(19) United States
(12) Patent Application Publication
(10) Pub. No.: US 2017/0119614 A1
(43) Pub. Date: May 4, 2017

(54) ACTUATOR DEVICE, METHOD AND SYSTEM FOR LIMB REHABILITATION

(71) Applicant: NATIONAL UNIVERSITY OF SINGAPORE, Singapore (SG)

(72) Inventors: Chen Hua YEOW, Singapore (SG); Jeong Hoon LIM, Singapore (SG); Jin Huat LOW, Singapore (SG); Hong Kai YAP, Singapore (SG); Fanzhe LOW, Singapore (SG)

(73) Assignee: NATIONAL UNIVERSITY OF SINGAPORE, Singapore (SG)

(21) Appl. No.: 15/317,730

(22) PCT Filed: Jun. 12, 2015
(86) PCT No.: PCT/SG2015/050156

§ 371 Date: Dec. 9, 2016

Related U.S. Application Data
(60) Provisional application No. 62/011,145, filed on Jun. 12, 2014.
(60) Provisional application No. 62/112,751, filed on Feb. 6, 2015.

(51) Int. Cl. A61H 1/02

(52) U.S. Cl. CPC A61H 1/0288; A61H 1/0266; A61H 2201/5069; A61H 2201/0103; A61H 2201/1238; A61H 2201/1635; A61H 2201/164; A61H 2201/165

(57) ABSTRACT

An actuator device, a method and a system for limb rehabilitation, and a pneumatic actuator element. The actuator device for limb rehabilitation comprises one or more pneumatic actuator elements; and means for coupling the pneumatic actuator elements to the limb at or near one or more joints of the limb; wherein each pneumatic actuator element comprises: an expandable main body having a longitudinal axis; one or more channel networks formed in the main body such that, in an acquiescent state of the pneumatic actuator element, a projected length of each channel network along the longitudinal axis is shorter than a total channel length of said each channel network.

### FIELD OF INVENTION

The present invention relates broadly to an actuator device, method and system for limb rehabilitation, in particular for hand and ankle rehabilitation.

### BACKGROUND

Impairment of motor function is the most common problem that surface after developing neurological disorders such as stroke or incurring injury such as post-traumatic arthritis. An individual will lose his or her ability to perform activities of daily living (ADLs) after motor function impairment.

For example, patients with hand function impairment are required to undergo continuous passive motion exercises, which involve repetitive tasks such as grasping and opposition motion. Robotic devices with the ability to carry out repetitive tasks have been proposed in order to assist the caregivers in the rehabilitation process and provide a more quantitative process. One example is the hand exoskeleton, which is situated around the hand to guide the finger joints into desired trajectories.

The design of conventional hand exoskeleton device involves cable-driven, linkage-based and pneumatically driven mechanism. Although there are certain advantages derived from these designs, such as rigid mechanical body support and linear force transmission that is predictable and easier to control, they also carry several disadvantages when the device interacts with the wearer. For example, cable driven and linkage-based devices such as described in P. Heo, G. Gu, S.-j. Lee, K. Rhee, and J. Kim, “Current hand exoskeleton technologies for rehabilitation and assistive engineering,” International Journal of Precision Engineering and Manufacturing, vol. 13, pp. 807-824, 2012 May 1 2012 are normally bulky and uncomfortable; while in pneumatically driven devices such as described in J. Arata, K. Ohmoto, R. Gassert, O. Lambercy, H. Fujimoto, and I. Wada, “A new hand exoskeleton device for rehabilitation using a three-layered sliding spring mechanism,” in Robotics and Automation (ICRA), 2013 IEEE International Conference on, 2013, pp. 3902-3907, precise attachment of actuators to the joint rotational centers is required and longer setup time is expected. Moreover, since conventional hand exoskeleton comprises rigid components such as motors and linear actuators, they induce high stresses on the supporting connectors between the exoskeleton and the hand as well as impede the natural movement of joints by constraining their non-actuated degrees of freedom (DOFs).

On another hand, deep vein thrombosis (DVT) is a severe complication among patients that could arise due to various clinical factors, where blood clots form in the deep veins of the lower extremity and affect normal blood flow.

Current prevention of DVT broadly falls into two categories; pharmacological prophylaxis and mechanical prophylaxis, where pharmacological prophylaxis entails using anti-coagulant drugs to prevent blood clotting. There are several commercially available mechanical prophylaxis systems that the hospitals usually adopt, where the approach is focused on promoting venous blood flow so as to resolve the problem of venous stasis. One such device is the intermittent pneumatic compression system that uses a pneumatic pump to compress the calf (Flowtron, Arjohuntleigh, Sweden), where the suggested pressure setting to compress the calf is 40 mmHg. Another device is the graduated compression stocking that utilizes a pressure gradient from the foot up till the thigh to promote venous blood flow (Covidien, Ireland). Such mechanical prophylaxis systems have side effects such as having skin breaks or falls with injury for the usage of the intermittent pneumatic system or ulcers, blisters and skin necrosis for usage of the graduated compression stockings.

Embodiments of the present invention provide an actuator device, a method and a system for limb rehabilitation, and a pneumatic actuator element that seek to address at least one of the above problems.

### SUMMARY

In accordance with a first aspect of the present invention, there is provided an actuator device for limb rehabilitation comprising one or more pneumatic actuator elements; and means for coupling the pneumatic actuator elements to the limb at or near one or more joints of the limb; wherein each pneumatic actuator element comprises: an expandable main body having a longitudinal axis; one or more channel networks formed in the main body such that, in an acquiescent state of the pneumatic actuator element, a projected length of each channel network along the longitudinal axis is shorter than a total channel length of said each channel network.

In accordance with a second aspect of the present invention, there is provided a method of limb rehabilitation using the device as defined in the first aspect.

In accordance with a third aspect of the present invention, there is provided system for limb rehabilitation comprising a device as defined in the first aspect; a pump system for selectively inflating and deflating the pneumatic actuator elements; and a controller for the pump system.

In accordance with a fourth aspect of the present invention, there is provided pneumatic actuator element comprising an expandable main body having a longitudinal axis; and one or more channel networks formed in the main body such that, in an acquiescent state of the pneumatic actuator element, a projected length of each channel network along the longitudinal axis is shorter than a total channel length of said each channel network.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIGS. 1 a)-c) show schematic diagrams illustrating a mold for fabrication of a pneumatic actuator element according to an example embodiment.

FIGS. 2 a)-b) show schematic diagrams illustrating bending action of a pneumatic actuator element according to an example embodiment.

FIGS. 3 a)-c) show schematic diagrams illustrating bending action of pneumatic actuator element according to example embodiments.

FIGS. 4 a)-c) show schematic diagrams illustrating bending action of pneumatic actuator device according to example embodiments.

FIG. 5 shows a schematic diagram illustrating a pneumatic actuator device according to an example embodiment.

FIGS. 6 a)-b) show schematic diagrams illustrating a pneumatic actuator device according to an example embodiment.

FIGS. 7 a)-b) show schematic diagrams illustrating bending action of the pneumatic actuator device of FIGS. 6 a)-b).

FIGS. 8 a)-b) show schematic diagrams illustrating a mold for fabrication of a pneumatic actuator element according to an example embodiment.

FIGS. 9 a)-c) show photographs of a prototype pneumatic actuator device according to an example embodiment in different actuation states.

FIG. 10a) shows a photograph of a prototype pneumatic actuator element pair according to an example embodiment.

FIG. 10b) shows a schematic diagram illustrating a pneumatic actuator device according to an example embodiment.

FIG. 11) shows a schematic diagram illustrating a system for limb rehabilitation according to an example embodiment.

FIG. 12 shows a screen shot illustrating an actuation-calibration program interface according to an example embodiment

FIGS. 13 a)-b) show photographs of a prototype pneumatic actuator device according to an example embodiment in different actuation states.

FIGS. 14 a)-b) show schematic diagrams illustrating a pneumatic actuator device according to an example embodiment in different actuation states.

FIGS. 15 a)-b) show schematic diagrams illustrating a pneumatic actuator device according to an example embodiment.

FIGS. 15 c)-e) show schematic diagrams illustrating the pneumatic actuator device of FIGS. 15 a)-b) in different actuation states.

FIGS. 16 a)-b) show schematic diagrams illustrating a mold for, and fabrication of, a pneumatic actuator element according to an example embodiment.

FIGS. 17 a)-b) show a schematic diagram illustrating an experimental set-up for characterization of a pneumatic actuator element according to an example embodiment and a graph of results obtained therewith, respectively.

FIG. 18 shows a graph of measured strain-force data obtained from a pneumatic actuator element according to an example embodiment.

FIGS. 19 a)-b) show graphs of measured ankle dorsiflexion/plantarflexion data obtained from a pneumatic actuator element according to an example embodiment.

FIGS. 20 a)-g) show schematic diagrams illustrating actuator elements according to example embodiments.

### DETAILED DESCRIPTION

Example embodiment of the present invention provide soft robotic gloves and socks designed to improve the patients' hand and ankle mobility respectively, and restore basic hand and ankle functions, such as hand opening/closing or ankle dorsiflexion-plantarflexion. The example embodiments described comprise soft pneumatic actuators to generate the desired bending and joint flexion. These soft wearable rehabilitation devices in example embodiments can advantageously be used to reduce the disabilities caused by neurological diseases, such as stroke or Parkinson's disease, so as to assist them in achieving the highest level of independence for activities of daily living.

Soft robots or robotic actuators for the example embodiments described herein are usually fabricated using the soft lithography technique. Briefly, a mold with special pneumatic networks is designed using computer-aided drawing and thereafter 3D-printed. Subsequently, elastomeric mixtures, such as (but not limited to) DragonSkin10, Smooth-On, Inc, silicone rubber, are poured into the mold and cured to create a negative replica of the mold, which is then sealed using another layer of elastomeric material which can be the same as or a different material from the one used to create the mold.

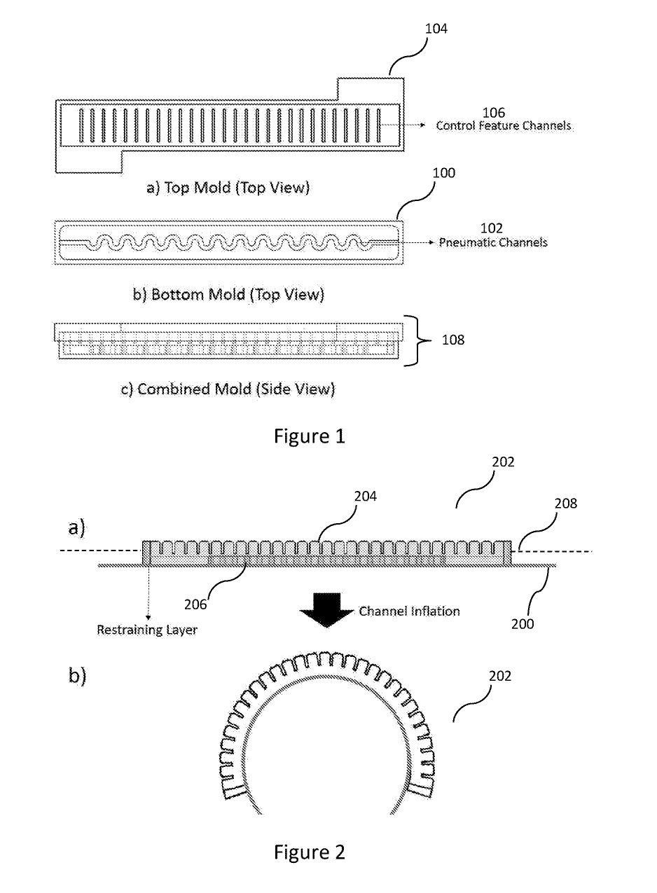

Preferably, example embodiments of the present invention are fabricated based on a modified soft lithography technique whereby a bottom mold 100 with pneumatic channel(s) 102 is designed, as shown in FIG. 1b). The pneumatic channel(s) 102 can be created using methods such as, but not limited to, 3D printing or a wire that is shaped into the desired feature profile. A top mold 104 is designed with control feature channels 106, see FIG. 1a).

The combined mold 108 is shown in FIG. 1c). A curing process using an elastomeric material (e.g. DragonSkin10 silicone rubber) is then executed to form an actuator/actuator element with an expandable main body. Once the elastomer is cured, the structure is bonded to a restraining layer 200 (such as fabric or a thicker layer of elastomeric material), forming a soft actuator 202. Upon pressurization, the pneumatic channel(s) will inflate towards the outer wall 204 having an undulated surface, corresponding to the feature channels 106, compare FIG. 1a), as an example of a textured surface opposite the restraining layer 200, which thus bends the soft actuator 202 and results in a bending motion, as illustrated in FIGS. 2a)-b).

The channel network 206 is formed such that, in an acquiescent or neutral state of the soft pneumatic actuator 202, the projected length of the channel network 206 along the longitudinal axis 208 of the actuator 202 main body is shorter than a total channel length of the channel network 206. As used herein, “acquiescent state” is intended to refer to a state in which the pneumatic actuator is subjected to ambient pressure conditions, i.e. with the pressure inside the channel network being substantially equal to the ambient pressure, e.g. at 1 atm.

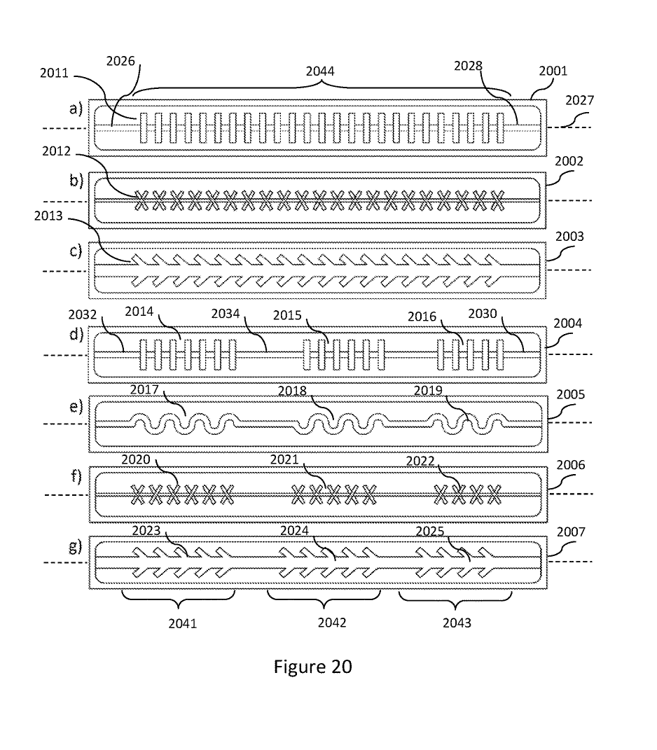

In various embodiments, the pneumatic channels can take various different forms, shapes and dimensions in which the projected length of each channel network along the longitudinal axis of the main body of the actuator is shorter than a total channel length of said each channel network. In FIGS. 20 a)-g), non-limiting example actuators 2001-2007 with different channel networks 2011-2025 are schematically illustrated, with respective longitudinal axes e.g. 2027 of the main bodies of the actuators. It is noted that the drawings in FIG. 20 are not intended to be to scale relative to one another, i.e. the relative sizes between the designs may vary. For example, the actuators 2004-2007 may have a length corresponding to a person's finger, with the respective channel networks e.g. 2014-2016 disposed at or near the different finger joints along the same finger. As another example, the actuators 2001-2003 may have a length corresponding to a person's finger or, in another example, smaller sized individual ones of the actuators 2001-2003 may be disposed at or near respective finger joints.

Linear channel portions e.g. 2026, 2028 can be provided at one or both ends of the channel network e.g. 2011 for actuators 2001-2003, and linear channel portions e.g. 2030, 2032 can be provided at one or both ends and linear portions e.g. 2034 can be provided between the channel networks e.g. 2014, 2015 for actuators 2004-2007, for connection/interconnection to a pneumatic source (not shown) such as a pump, possibly with two or more actuators connected in series and/or in parallel to one or more pneumatic sources.

The actuators 2001-2003 exemplify a single channel network e.g. 2044 in a single pneumatic actuator element, whereas the actuators 2004-2007 exemplify two or more channel networks e.g. 2041-2043 in a single pneumatic actuator element.

Unlike existing robotic devices which use actuators that are less compliant and not compatible with human joint stiffness and/or tend to be heavy and difficult to operate, embodiments of the present invention advantageously address these challenges. Example embodiments of the soft actuator can preferably be used for rehabilitation application (both hand and ankle therapies). The design of a soft actuator according to example embodiments can lead to greater advances for rehabilitation since it advantageously is more wearable, lighter and provides safer human-robotic interactions.

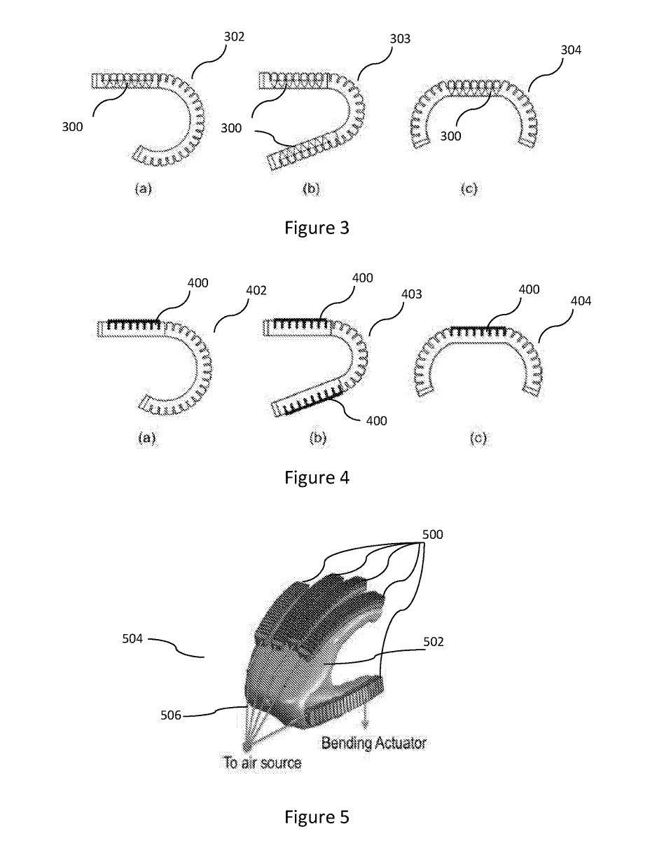

In various embodiments of the present invention, an additional control mechanism to control the bending motion profile of the soft actuator. In one embodiment, This is implemented by embedding high strength thread or threads such as, but not limited to, Kevlar thread or threads 300 as an example of restraining structures in soft actuators 302-304, as shown e.g. for front end bending restricted, front and back end bending restricted, and middle bending restricted designs in FIGS. 3 a)-c) respectively. Various suitable materials may be used for the thread or threads 300, including, but not limited to, nylon, polyvinylidene fluoride (PVDF), polyethylene, Dacron and Dyneema (UHMWPE).

In different embodiments, this can be implemented by incorporating a modular sleeve(s) or clip(s) 400 as an example of restraining structures in soft actuators 402-404 on top of the control feature channels e.g. 404 in order to restrict the bending of certain part of the actuator, as shown e.g. for front end bending restricted, front and back end bending restricted, and middle bending restricted designs in FIGS. 4 a)-c) respectively. Various suitable materials may be used for the sleeve(s) or clip(s) 400, including any stiffer and non-elastic material compared to the soft actuators such as, but not limited to, plastic, paper, cloth, textile, fabric, non-woven fabric.

Such embodiments preferably improve the customizability of the actuator and are especially beneficial for patient-specific personalized rehabilitation procedures.

In various embodiments, the soft bending actuators 500 can be attached onto the finger segments of a glove 502 as an example of a means for coupling the pneumatic actuator elements to a limb at or near one or more joints of the limb, which thus provides a soft robotic glove 504 for hand rehabilitation, as illustrated in FIG. 5. Inflation of the actuators 500 can move the hand into various postures, for example, a proximal interphalangeal joint flexion, metacarpophalangeal joint flexion, or a grasping posture, depending on how the above-mentioned control mechanism is applied to the actuators 500 in the various embodiments. Various suitable materials may be used for the glove 504, including typical glove materials such as, but not limited to, Lycra, Neoprene, Elastane, Cotton, Cloth, knitted or felted wool, leather In various example embodiments, each of the soft pneumatic actuators 500 can have their own dedicated inlet e.g. 506, such that they can be individually actuated to move a desired finger or actuated in a certain combination to achieve a desired hand therapeutic configuration.

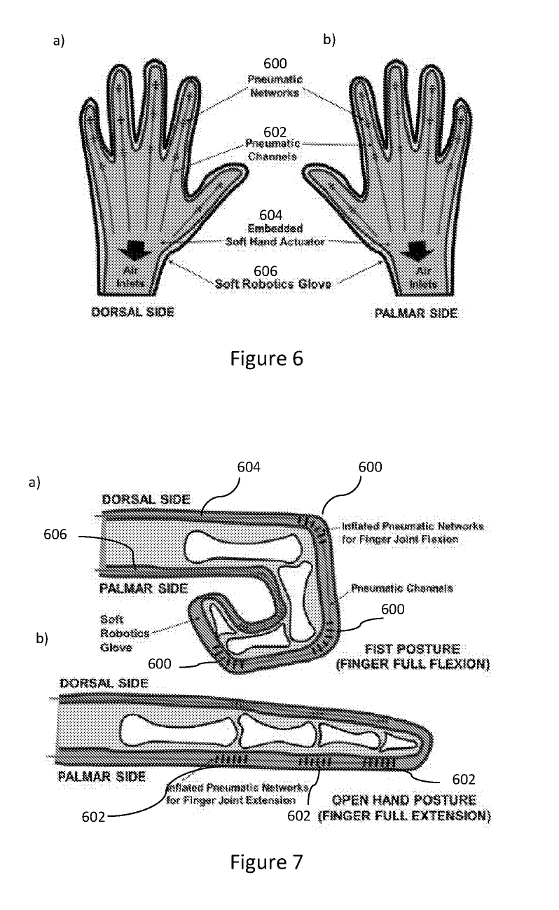

In various embodiments, soft actuators with localized pneumatic features or networks 600 at respective finger joints with substantially linear pneumatic channels 602 can be used, embedded in a glove 604 as an example of a means for coupling the pneumatic actuator elements to the limb at or near one or more joints of the limb to provide a robotics glove 606, as illustrated in FIGS. 6a)-b). Inflation of these bending actuators 600, 602 can create flexion or extension motions at each finger joint, depending on whether the dorsal or palmar actuators 600, 602 are inflated, as illustrated in FIGS. 7 a)-b). As shown in FIG. 7 a)-b), respective separate linear channels 604, 606 interconnect the dorsal and palmar actuators 600, 602 for selective dorsal and palmar actuator control. That is, in such embodiment the soft pneumatic features are made smaller to cover individual finger joints, rather than the whole finger segment, so as to enable isolated flexion-extension of each finger joint. It will be appreciated that the actuators 600, 602 can be fabricated individually using a mold such as the mold 108 described above with reference to FIGS. 1 a)-c) and interconnected via respective linear channel portions, or using a larger mold with several localized pneumatic features interconnected by linear channel portions.

A two-part 3D-printed reusable mold is used in various example embodiments to fabricate soft bending actuators with variable stiffness. As shown in FIG. 16 a), the lower-part mold (channel mold) 1600 is used to create pneumatic channels inside the actuator, which will inflate upon pressurization, while the upper-part mold (feature mold) 1604 is used to impose variable stiffness at different localities of the actuator, which determine the bending profile of the actuator.

The design of the feature mold 1604 can be customized for patient-specific applications, i.e. the dimension and features at the upper-part mold are designed according to the dimension of the patient's hand as well as different therapy exercises required. After confirming the dimension and the exercises required, the feature mold 1604 can e.g. be designed using CAD software (Dassault Systémes SolidWorks Corp., USA) and 3D printed (Object500 Connex, Stratasys Ltd., USA). The fabrication process for the actuator 1616 with variable stiffness is illustrated in FIG. 16 b), according to an example embodiment. At step i), the channel mold 1600 is provided. At step ii), a liquid elastomer 1602 (such as, but not limited to, DragonSkin10, Smooth-On, Inc) is poured into the channel mold 1600. At step iii), the feature mold 1604 is placed on top of the filled channel mold 1600 to create a corrugated accordion-like outer later in this example embodiment. At step iv) The ensemble is cured under about 60° C. under ambient pressure, e.g. about 1 atm, for about 15 minutes in an example embodiment. At step v) the bottom 1606 of the cured structure 1608 is sealed with strain restraining layer 1609, such as, but not limited to, paper, cloth, woven fiberglass, Polydimethylsiloxan (PDMS). At step vi) an accordion-shaped fabric 1610 is attached to both the distal and proximal ends of the actuator 1616 in order to prevent over-expansion of the outer layer 1612.

Upon pressurization, the actuator will bend at the localities that have lowest stiffness. With different stiffness assigned to different localities, the actuator can conform to different shapes, not only a typical circular configuration. A control system and pneumatic system are assembled in various embodiments in order to allow isolated control of each actuator. Air can be supplied for example via a compressor or a miniature diaphragm pump for actuation.

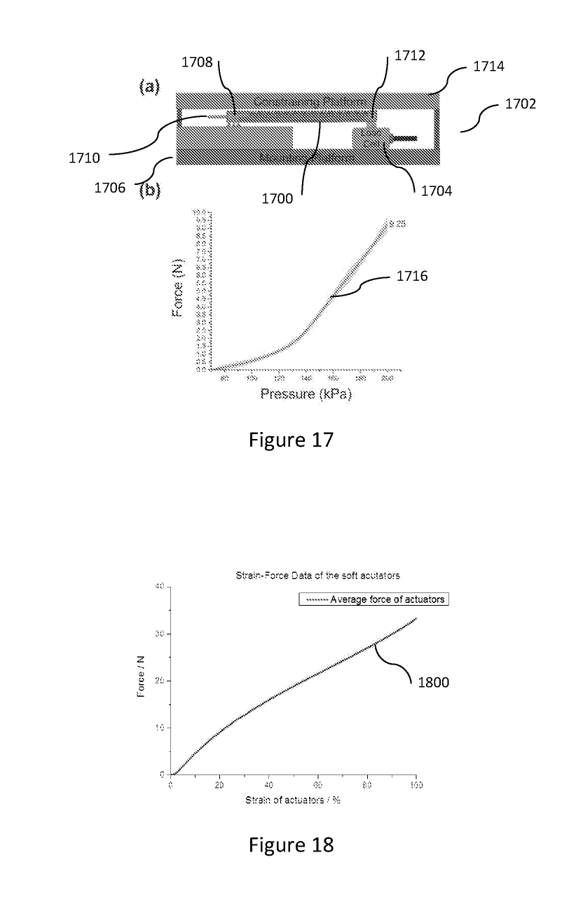

The tip force exerted by an actuator 1700 according to an example embodiment was measured over increasing pressures using a customized force measurement setup 1702 illustrated in FIG. 17 a). The system 1702 consists of a compression load cell 1704 (FC22, Measurement Specialties Inc, USA) and a mounting platform 1706. The proximal end 1708 of the actuator 1700 was mounted on the platform 1706 and connected to the air source (not shown) via a connecting tube 1710. The distal end 1712 of the actuator 1700 was in contact with the load cell 1704. A constraining platform 1714 was positioned on top of the actuator 1700.

During pressurization, the actuator 1700 flexed and started to contact with the constraining platform 1714, which constrained the height and the curvature of the actuator 1700. The bending force generated along the actuator 1700 was transmitted to the distal end 1712 where it could be measured by the load cell 1704.

The tip force increased with increased pressure, see curve 1716 in the graph shown in FIG. 17 b). The maximum force and maximum actuation pressure for a sample set of actuators were 9.25±0.48N and 200 kPa. It is estimated that a minimum force of 8N is preferred to achieve a palmar grasp and manipulate most objects of daily living. Thus, the tip force of the sample set of actuators was estimated to be advantageously sufficient to actuate the fingers of a person and to achieve a grasping action.

To test the compatibility of soft robotic gloves according to various embodiments under MR environment, phantom tests were conducted and the variations of signal to noise ratio (SNR) of the images were computed. A Siemens standard spherical phantom composed of NiSO4x6H2O was used as a phantom for the SNR measurements. The phantom control images were first acquired without the presence of the glove.

In one trial, a soft robotic glove according to an example embodiment was placed on the scanner table. Silicon pneumatic tubes were connected to the actuator and the distal ends of the tubes were connected to the pneumatic valves of a control system located outside the MR room. The phantom images were then acquired with the presence of MRC-Glove. The phantom remained stationary throughout the entire tests.

In another trial, the phantom images were obtained in the presence of the soft robotic glove, with actuators activated. The actuators were activated according to a preset sequence. The control system activated the pneumatic valves and the air compressor supplied the air to the actuators through the valves. In one cycle of CPM exercise, the valves were activated for 3 s and deactivated for another 3 s. The supply pressure was set at 200 kPa. 3 s and 200 kPa were the activation time and the supply pressure that corresponded to full finger flexion based on the results from range of motion test outside the MR environment.

In another trial, human tests were conducted with a healthy human subject who underwent continuous passive motion (CPM) hand exercises assisted by the soft robotics glove, which was activated according to a preset experimental paradigm.

From the results of the above described trials, it could be concluded that advantageously the quality of the images did not alter significantly regardless of the introduction and operation of soft robotics gloves according to various embodiments.

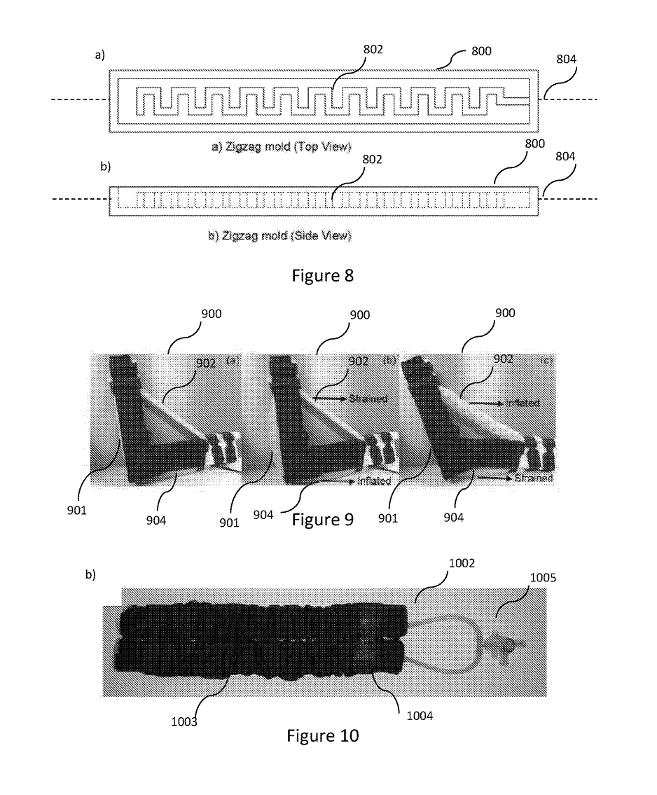

In various embodiments, a soft actuator can also be fabricated in a larger dimension with compact pneumatic channels, such as in a zig-zag pattern, so that expansion of these pneumatic channels will create inflated pockets that extend the actuator. Such a channel pattern can also reduce the overall stiffness of the actuator. An example mold for fabrication of such a soft actuator 800 is illustrated in FIGS. 8 a) and b). The zig-zag pattern 802 is again designed such that a channel network is formed in the fabricated soft actuator which, in an acquiescent or neutral state of the soft actuator, has projected length along the longitudinal axis (corresponding to longitudinal axis 804 of the mold 800) that is shorter than a total channel length of the channel network.

In various embodiments providing a soft robotic socks device 900, soft actuators 901, 902 of the type fabricated using a mold such as mold 800 described above with reference to FIG. 8 can be placed onto the plantar (i.e. base of foot) and dorsal (i.e. top of foot) parts respectively of the sock 904 as an example of a means for coupling the actuator to a limb of a person, as shown in FIG. 9 a). The uninflated actuators 901, 902 hold the ankle in tension on the dorsal and ventral sides, keeping it in a neutral posture. Upon inflation of the ventral actuator 901, the actuator 901 expands and relaxes its tension, allowing the ankle to be moved into dorsiflexion by the strained dorsal actuator 902, see FIG. 9 b). Upon inflation of the dorsal actuator 902, the actuator expands and relaxes its tension, allowing the ankle to be moved into plantarflexion by the strained ventral actuator 901.

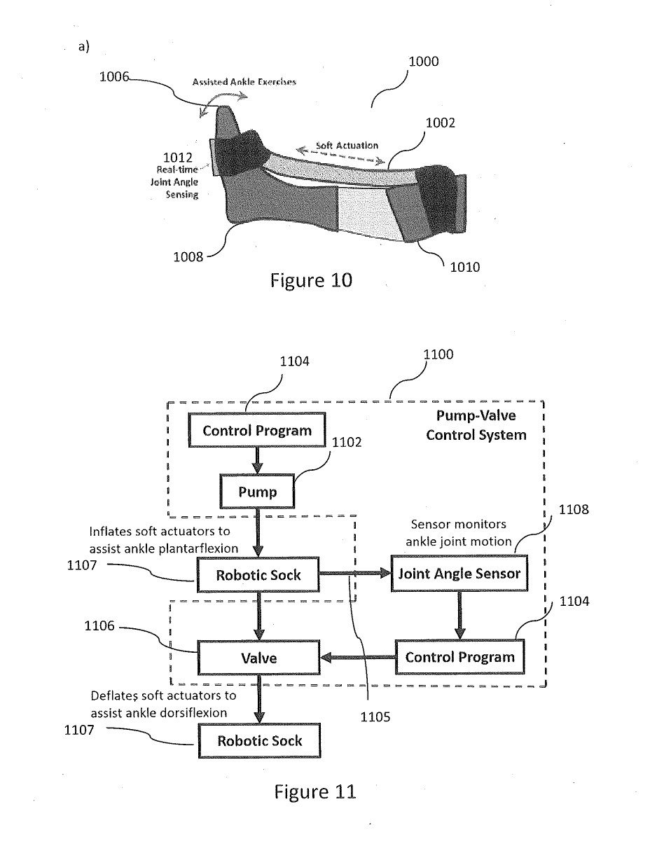

In various embodiments, a soft robotics socks-type device 1000 is provided in which a double-extension soft actuator 1002 can be placed on the ventral side of the shin 1004, as illustrated in FIGS. 10 a)-b). The double-extension soft actuator 1002 comprises a pair of single soft extension actuators, such as of the type that can be fabricated with the mold illustrated in FIGS. 8 a)-b), which may each be encased in fabric 1003 and connected to each other at the distal ends thereof, for example using straps 1004. The pair of single soft extension actuators can be connected in parallel to a common air source, e.g. through a single valve and T-junction 1005. The actuation concept is such that when the double-extension soft actuator 1002 is inflated, the actuator 1002 will extend and push the foot 1006 distally, which thus assists in ankle plantarflexion. On the other hand, when the actuator 1002 is deflated, the actuator 1002 will contract back to its original length, and the resultant tension will assist in ankle dorsiflexion motion. It is noted that “deflated” as used herein is intended to include bot venting to the ambient pressure and/or active pumping-out of the channel(s) of the actuator(s), and may include evacuating the channel(s) to pressures below ambient pressure.

The soft robotics socks-type device 1000 is a modular design, comprising of different modules, namely: Sock 1008 as an example of a means for coupling the pneumatic actuator elements to the limb at or near one or more joints of the limb, Knee Sleeve 1010 as an example of a means for coupling the pneumatic actuator elements to the limb at or near one or more joints of the limb, Soft Double-Extension Actuator 1002, Joint Angle Sensor 1012 and Programmable Pump-Valve Control System 1100 (FIG. 11). These modules can be easily assembled onto a patient, while allowing for positional adjustment of the modules, depending on the patient's lower leg dimensions. The ankle joint motion is captured by the embedded joint angle sensor 1012 placed on the plantar side of the sock 1008, which allows wireless transmission to the therapist's desktop/laptop in example embodiments, for observing the ankle joint range of motion that the patient is undergoing during the robot-assisted therapy.

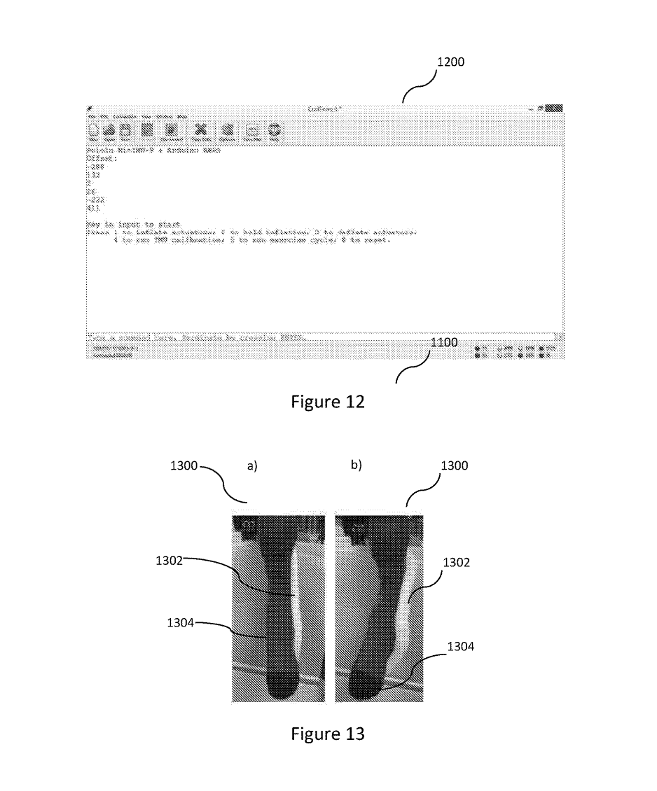

The main components of the programmable pump-valve control system 1100 illustrated in FIG. 11 include the motor pump 1102, Control program/microcontroller 1104, Xbee (or other) wireless transceiver link 1105 between the sensing element (not shown) on the soft robotic sock device 1107 and joint angle sensor unit 1108, and electronic valve 1106. The system 1100 is installed with an actuation-calibration program, and an actuation-calibration program interface 1200 according to an example embodiment is shown in FIG. 12. The following functions can be included: Functions “1”-“3” control the actuator inflation, hold pressure and deflation respectively, Function “4” runs the calibration of the joint angle sensor to determine active ankle joint range of motion, Function “5” runs the exercise cycle for the ankle with a predetermined duration and inflation/deflation timing with simultaneous joint angle sensor/inertial measurement unit (IMU) feedback on the ankle joint angle, and Function “8” resets the joint angle sensor for use in another patient.

As will be appreciated by a person skilled in the art, such system and interfaces may be specially constructed for the required purposes, or may comprise a device selectively activated or reconfigured by a computer program stored in the device. Such a computer program may be stored on any computer readable medium. The computer readable medium may include storage devices such as magnetic or optical disks, memory chips, or other storage devices suitable for interfacing with a device. The computer readable medium may also include a hard-wired medium or wireless medium. The computer program when loaded and executed on the device effectively results in an apparatus that implements the steps of the control method.

Such systems may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

Returning to FIGS. 10 a)-b), calibration of soft actuators 1002 made from DragonSkin10, Smooth-On, Inc, elastomeric material according to various embodiments had a positive strain-force relationship and were able to exert a peak force of 33.2±0.3N at 100% strain, see curve 1800 in the graph shown in FIG. 18. The strain-force behavior of the actuators was tested on a static tensile stretching machine (Instron, USA) by controlling the rate of extension of the actuator and measuring the resultant force output. For this calibration setup, the soft actuators were pulled to about 100% strain with an initial length of about 25 cm at a constant strain rate for about 30 s.

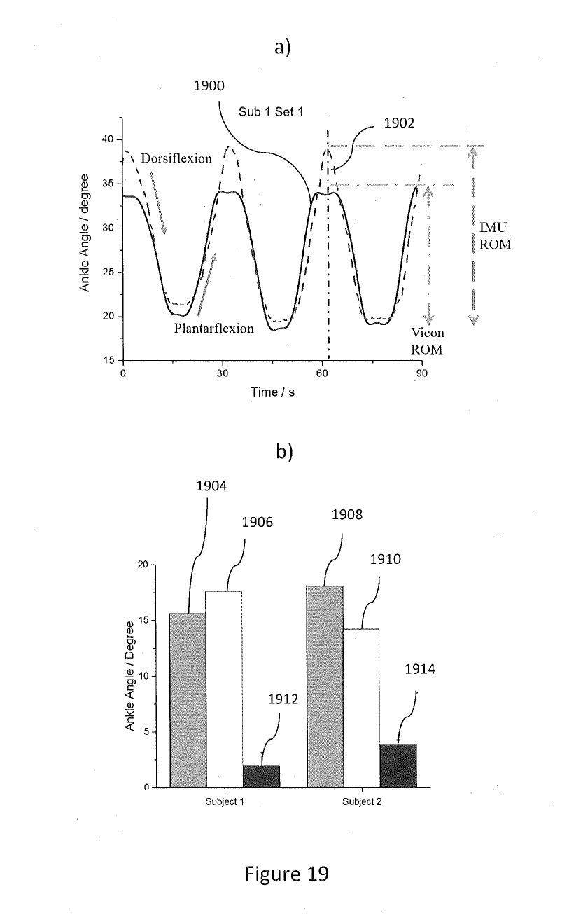

For subject testing, the average photographically determined robotic-assisted ankle flexion using an example embodiment on the subject was 15.6±0.8°, while the inertial measurement unit (IMU) determined robotic-assisted ankle flexion using the same example embodiment on the subject was 17.6±1.9°, see curves 1900 and 1902 respectively in the graph shown in FIG. 19 a) and columns 1904 and 1906 in the graph shown in FIG. 19 b). For another example subject, the average photographically determined robot-assisted ankle flexion was 18.1±0.1° while the IMU determined robotic-assisted ankle flexion using the same example embodiment on the further subject was 14.3±0.6°, see columns 1908 and 1910 in the graph shown in FIG. 19 b). For the absolute difference between the photographically determined and the IMU determined robotic-assisted ankle flexion, the average error was 2.7±1.4 see columns 1912 and 1914 in the graph shown in FIG. 19 b).

The actuators according to various embodiments function on the concept of using material elasticity to create tension which caused ankle dorsiflexion. Accordingly, by varying the type of soft elastomers used, actuators of different strain-force profiles can advantageously be provided.

In various embodiments, by encasing the actuators within a pre-sewn fabric 1003, see FIG. 10 a), the actuation profile of the actuators can advantageously be controlled. With the fabric in place, the radial actuation can preferably be reduced thereby allowing for better actuation axially to facilitate extension and contraction of the actuators.

Additionally or alternatively, the fabric casing can also advantageously prevent over-inflation radially that can potential damage the actuators by bursting.

The IMU was attached onto the metatarsal region of the heel in various embodiments, so as to provide real-time feedback of the joint ankle motion. Together with the wireless capability of the electronic system in various embodiments, the real-time feedback data can be provided to therapists or doctors alike so that they could monitor the ankle exercise. This real-time feedback also allows for monitoring of any improvement of the passive range of motion of the ankle.

For the IMU placed on the metatarsal region of the subject in various example embodiments, it was assumed that the lower limb of the subject was parallel to the ground throughout the duration of the passive exercises. It is noted, however, that the application is not limited to plantar or dorsal metatarsal regions, but additionally or alternatively placement can be on the lateral and medial sides in different embodiments. Although there were still slight deviation in the reported IMU value when comparing with actual ankle joint angle due to attachment of the IMU on the sock and thus coupled to the soft tissue, this was found to not be a critical issue since the main function of the IMU was to provide real-time feedback for the physicians where they can capture patient's joint motion wirelessly while away from the patients' beds. This acts as a form of interaction of the efficacy of the passive exercise and thereby allowing the physicians to alter the parameters of the exercise such as the duration per exercise cycle. Implementing a proper calibration procedure prior to the usage of the IMU can advantageously further improve the accuracy of the IMU determined range of motion.

In various embodiments, a soft robotic socks device 1300 is provided in which the actuator 1302 can be placed on the medial and/or lateral sides of the sock 1304 as an example of a means for coupling the pneumatic actuator elements to the limb at or near one or more joints of the limb to provide assisted supination and pronation, as shown in FIGS. 13 a)-b).

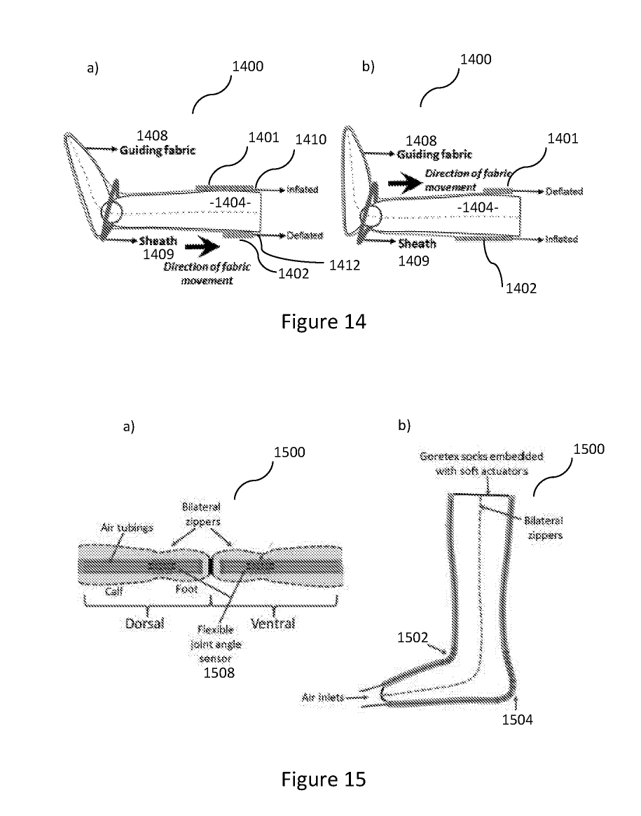

In various embodiments, a soft robotics socks-type device 1400 is provided in which the actuators 1401, 1402 can be placed on the ventral and dorsal sides of the shin 1404 respectively using a sleeve (not shown) as an example of a means for coupling the pneumatic actuator elements to the limb at or near one or more joints of the limb, as illustrated in FIGS. 14 a)-b). The actuators 1401, 1402 are connected to the dorsal and ventral sides of the toes via a guiding fabric 1408 to simulate a tendon-sheath mechanism, compare the guiding fabric 1408 and the fabric sheath element 1409 in FIGS. 14 a)-b). Respective separate air inlets 1410, 1412 for the actuators 1401, 1402 are provided for selective actuator control. Upon inflation of the ventral actuator 1401, the actuator 1401 expands and relaxes its tension, allowing the ankle to be moved into plantarflexion by the strained dorsal actuator 1402, see FIG. 14 a). Upon inflation of the dorsal actuator 1402, the actuator 1402 expands and relaxes its tension, allowing the ankle to be moved into dorsiflexion by the strained ventral actuator 1401, see FIG. 14 b). Various suitable materials may be used for the sleeve(s) or clip(s) 400, including any cloth material such as, but not limited to, cotton, denim, wool, Lycra.

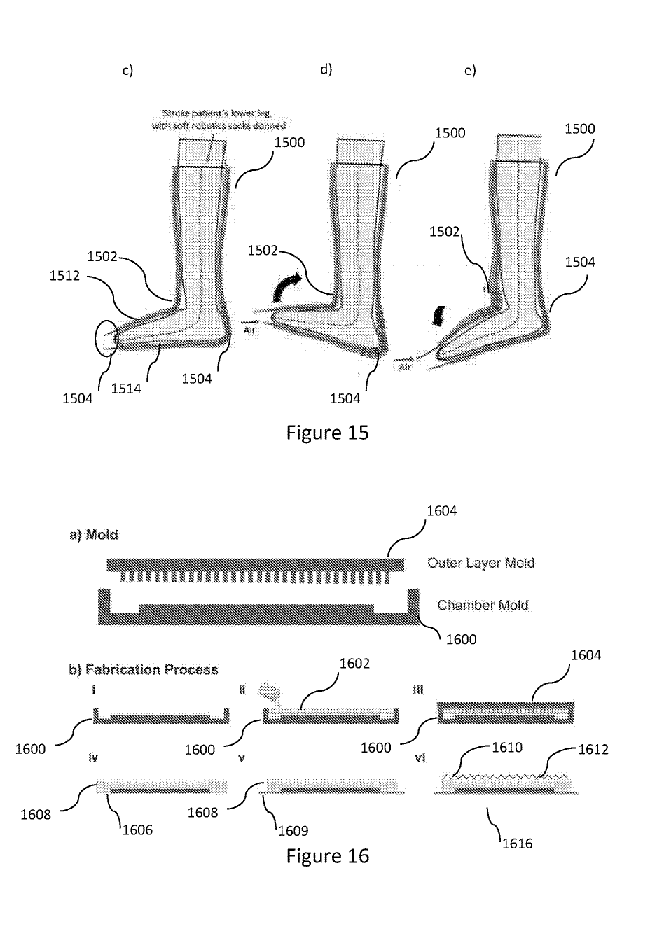

In various embodiments, a soft robotics socks device 1500 is provided in which a zipper-based concept is used for easy donning and soft actuators 1502, 1504 are embedded or incorporated on the ventral and dorsal side respectively of the sock 1506 as an example of a means for coupling the pneumatic actuator elements to the limb at or near one or more joints of the limb donned onto the foot/ankle joint, as illustrated in FIGS. 15 a)-e). Inflation of the dorsal actuator 1502 bends the ankle outwards for plantarflexion as illustrated in FIG. 15 e), while inflation of the ventral actuator 1504 bends the ankle inwards for dorsiflexion, as illustrated in FIG. 15 d). The sock 1506 may be made from material such as, but not limited to, Goretex, W. L. Gore & Associates, USA.

The soft robotics socks device 1500 also comprises flexible joint angle sensors 1508, see FIG. 15 a), and air inlets 1510, see FIG. 15 c). Respective separate linear channels 1512, 1514 connected to the actuators 1502, 1504 are provided for selective actuator control.

In one embodiment, an actuator device for limb rehabilitation is provided comprising one or more pneumatic actuator elements; and means for coupling the pneumatic actuator elements to the limb at or near one or more joints of the limb; wherein each pneumatic actuator element comprises: an expandable main body having a longitudinal axis; one or more channel networks formed in the main body such that, in an acquiescent state of the pneumatic actuator element, a projected length of each channel network along the longitudinal axis is shorter than a total channel length of said each channel network.

The device may further comprise a restraining layer coupled to the expandable main body for guiding a deformation of the main body caused by inflation of the channel network.

The device may be configured for hand rehabilitation.

The main body may comprise a textured surface for facilitating expansion of the main body caused by inflation of the channel network.

The device may further comprise one or more restraining structures coupled to the main body for substantially inhibiting expansion of the main body in at least a portion thereof.

The means for coupling the pneumatic actuator elements to the limb may comprise a glove.

At least one pneumatic actuator element may be disposed on the dorsal side of the glove.

At least one pneumatic actuator element may be disposed on the palmar side of the glove.

Pairs of pneumatic actuator elements may be disposed at or near each of the joints.

One pneumatic actuator of each pair may be disposed on the dorsal side of the glove and the other one on the palmar side of the glove.

The device may be configured for ankle rehabilitation.

The device may comprising a coupled pair of pneumatic actuator elements, wherein the means for coupling the pneumatic actuator elements to the limb comprises a first coupling element for coupling first ends of the pair of pneumatic actuator elements to the foot and a second coupling element for coupling second ends of the pair of pneumatic actuator elements to the leg, such that the pair of pneumatic actuator elements extends across the ankle.

The device may comprise at least two pneumatic actuator elements, wherein the means for coupling the pneumatic actuator elements to the limb is configured to couple the two pneumatic actuator elements on opposite sides of the leg, the device further comprising a guiding fabric coupled at one end thereof to the first pneumatic actuator element and at the other end thereof to the second pneumatic actuator element, the device further comprising a sheath for receiving the foot therein, with the guiding fabric extending substantially around the foot and through the sheath.

The means for coupling the pneumatic actuator elements to the limb may comprise a sock element, the sock element having at least two pneumatic actuator elements embedded therein for disposition at or near opposite sides of the ankle when the sock element is worn.

The sock element may comprise two complimentary portions connected by bilateral fastening means such as zippers.

The device may be configured for ankle plantarflexion/dorsiflexion.

The device may be configured for ankle supination/pronation.

The device may further comprise a sensor for monitoring movement of the one or more joints.

In one embodiment, a method of limb rehabilitation using the device as described in the above embodiments is provided.

In one embodiment, a system for limb rehabilitation is provided comprising a device as described in the above embodiments; a pump system for selectively inflating and deflating the pneumatic actuator elements; and a controller for the pump system.

The system may further comprise a sensor for monitoring movement of the one or more joints.

In one embodiment, a pneumatic actuator element is provided comprising: an expandable main body having a longitudinal axis; and one or more channel networks formed in the main body such that, in an acquiescent state of the pneumatic actuator element, a projected length of each channel network along the longitudinal axis is shorter than a total channel length of said each channel network.

The device according to various embodiments can advantageously be suitable to provide passive actuation of the ankle continuously until the user stops the electronic setup. Therefore, the device according to various embodiments is advantageously able to provide up to hundreds of cycles of dorsiflexion and plantarflexion an hour.

The soft actuators according to various embodiments showed consistent strain-force data. Therefore, when using the soft actuators according to various embodiments for passive ankle exercises, one can vary the initial length of the actuators and the strain profile with the pneumatic pump-valve system to cater to different ankle stiffness's of the subjects.

These described example embodiments can preferably unravel the effect of soft rehabilitation robotics on brain stimulation, which is usually difficult to achieve if the robotic device comprises of conventional motors made of ferrous components. In other words, the soft-robotics-assisted therapy according to example embodiments can be concurrently conducted with functional magnetic resonance imaging (fMRI) to determine the extent of brain stimulation.

Embodiments of the present invention can provide one or more of the following advantages:

(1) The pneumatic features within the soft actuators can be patterned into various designs to cover different actuation requirements

(2) These soft actuators can be restrained at desired localities via the use of external restraining structures such as Kevlar threads and modular sleeves.

(3) These soft actuators can be embedded onto various wearable fabrics such as socks and gloves to provide assisted motions in certain desired directions or orientations.

(4) The soft actuators can simulate natural human motions as compared to traditional hard robotics which are bulky, rigid and complicated

(5) The soft actuators are highly customizable and especially beneficial for personalized patient-specific applications.

(6) The soft actuators can be combined with fMRI to study the therapeutic effect on brain stimulation.

(7) By using different strengths materials and/or different strengths air pump sources can provide bending forces meeting different strength requirements.

Industrial applications of example embodiments can include one or more of:

(1) hand and ankle rehabilitation for neurological diseases patients, and

(2) investigate the effect of soft-robotics-assisted therapy on brain stimulation using fMRI.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features, in particular any combination of features in the patent claims, even if the feature or combination of features is not explicitly specified in the patent claims or the present embodiments.

For example, it will be appreciated that programmable pump-valve control systems such as the one described with reference to FIGS. 11 and 12 can be used for the various different embodiments described herein.

For example, it will be appreciated that while example implementations of the means for coupling the pneumatic actuator elements to the limb at or near one or more joints of the limb have been described above, various other functional designs can be used in different embodiments.

For example, it will be appreciated that while example implementations of the textured surface have been described above, various other functional designs can be used in different embodiments.

For example, it will be appreciated that while example implementations of the restraining structures have been described above, various other functional designs can be used in different embodiments.

For example, it will be appreciated that the shape and configuration of the main body of the actuator elements is not limited to the shape and configuration described in the example embodiments.

1. An actuator device for limb rehabilitation comprising:
one or more pneumatic actuator elements; and
means for coupling the pneumatic actuator elements to the limb at or near one or more joints of the limb;
wherein each pneumatic actuator element comprises:
an expandable main body having a longitudinal axis;
one or more channel networks formed in the main body such that, in an acquiescent state of the pneumatic actuator element, a projected length of each channel network along the longitudinal axis is shorter than a total channel length of said each channel network.

2. The device as claimed in claim 1, further comprising a restraining layer coupled to the expandable main body for guiding a deformation of the main body caused by inflation of the channel network.

3. The device as claimed in claim 1, configured for hand rehabilitation.

4. The device as claimed in claim 3, wherein the main body comprises a textured surface for facilitating expansion of the main body caused by inflation of the channel network.

5. The device as claimed in claim 3, further comprising one or more restraining structures coupled to the main body for substantially inhibiting expansion of the main body in at least a portion thereof.

6. The device as claimed in claim 3, wherein the means for coupling the pneumatic actuator elements to the limb comprises a glove.

7. The device as claimed in claim 6, wherein at least one pneumatic actuator element is disposed on the dorsal side of the glove.

8. The device as claimed in claim 6, wherein at least one pneumatic actuator element is disposed on the palmar side of the glove.

9. The device as claimed in claim 6, wherein pairs of pneumatic actuator elements are disposed at or near each of the joints.

10. The device as claimed in claim 9, wherein one pneumatic actuator of each pair is disposed on the dorsal side of the glove and the other one on the palmar side of the glove.

11. The device as claimed in claim 1, configured for ankle rehabilitation.

12. The device as claimed in claim 11, comprising a coupled pair of pneumatic actuator elements, wherein the means for coupling the pneumatic actuator elements to the limb comprises a first coupling element for coupling first ends of the pair of pneumatic actuator elements to the foot and a second coupling element for coupling second ends of the pair of pneumatic actuator elements to the leg, such that the pair of pneumatic actuator elements extends across the ankle.

13. The device as claimed in claim 11, comprising at least two pneumatic actuator elements, wherein the means for coupling the pneumatic actuator elements to the limb is configured to couple the two pneumatic actuator elements on opposite sides of the leg, the device further comprising a guiding fabric coupled at one end thereof to the first pneumatic actuator element and at the other end thereof to the second pneumatic actuator element, the device further comprising a sheath for receiving the foot therein, with the guiding fabric extending substantially around the foot and through the sheath.

14. The device as claimed in claim 11, wherein the means for coupling the pneumatic actuator elements to the limb comprises a sock element, the sock element having at least two pneumatic actuator elements embedded therein for disposition at or near opposite sides of the ankle when the sock element is worn.

15. The device as claimed in claim 14, wherein the sock element comprises two complimentary portions connected by bilateral fastening means such as zippers.

16. (canceled)

17. (canceled)

18. The device as claimed in claim 1, further comprising a sensor for monitoring movement of the one or more joints.

19. A method of limb rehabilitation using the device as claimed in claim 1.

20. The device as claimed in claim 1, further comprising:
a pump system for selectively inflating and deflating the pneumatic actuator elements; and
a controller for the pump system.

21. The device as claimed in claim 20, further comprising a sensor for monitoring movement of the one or more joints.

22. A pneumatic actuator element comprising:
an expandable main body having a longitudinal axis; and
one or more channel networks formed in the main body such that, in an acquiescent state of the pneumatic actuator element, a projected length of each channel network along the longitudinal axis is shorter than a total channel length of said each channel network.
